(19) United States
(12) Patent Application Publication
(10) Pub. No.: US 2011/0060984 A1
(43) Pub. Date: Mar. 10, 2011

(54) Method and apparatus for word prediction of text input by assigning different priorities to words on a candidate word list according to how many letters have been entered so far by a user

(76) Inventor: Yung-Chao Lee, Taoyuan County (TW)

(21) Appl. No.: 12/554,917

(22) Filed: Sep. 6, 2009

(51) Int. Cl. G06F 17/21

(52) U.S. Cl. 715/261

(57) ABSTRACT

A method for word prediction of text input on an electronic device includes receiving from a user interface a number of letters, performing word correction according to the received letters to thereby generate a set of first candidate words that have a number of letters being within a predetermined range, performing word completion according to the letters inputted to thereby generate a set of second candidate words that have more letters than the number of letters inputted so far, outputting a word candidate list via the user interface in an order according to a priority ranking. A higher priority is assigned to the first candidate words while the number of letters inputted so far is within the predetermined range; otherwise, a higher priority is assigned to the second candidate words.

### BACKGROUND OF THE INVENTION

1. Field of the Invention

The present invention relates to word prediction of text input, and more particularly, to correcting and completing with high accuracy words that a user may be trying to enter so that the user can quickly select the intended word on a word candidate list.

2. Description of the Prior Art

Instant messaging, e-mail, and other text based tasks are difficult to complete on portable electronic devices such as mobile phones due to the very limited space available for user interface elements on these devices. Keypads and keyboards, if present at all, are reduced to very inconvenient sizes. In other devices, to maximize display size, keypads are eliminated altogether, and soft input panels such as a touch screens are instead utilized to perform combined display and user input functions. Regardless of the technology involved, the miniature nature of the user interface makes typing words on such devices increasingly frustrating for users.

To solve this problem, word prediction features are often incorporated into devices having small form factors. To maximize speed of text entry, the state of the art word prediction feature involves trying to guess a user's intended word before the user has completed typing all the letters of that word. As the user types letters, a word prediction algorithm will attempt to guess all the possible words that begin in a corresponding manner entered by the user. These guessed words are presented to the user for direct selection, which can greatly speed up text entry.

One problem with this approach is that, due to the limited screen size, it is impossible to present in an efficient manner all the possible words for the user to select their desired word. Instead, only a handful of possible words can be displayed at any one time for user selection. Scrolling through multiple sections of the list of possible words is often more frustrating to a user than simply finishing typing the word in full or correcting a spelling mistake that is causing the prediction algorithm to guess incorrect words. An improved method and apparatus for word prediction of user input on an electronic device would be beneficial.

### SUMMARY OF THE INVENTION

It is therefore one of the objectives of the present invention to solve the above-described problem by assigning different priorities to candidate words outputted on a word candidate list of an electronic device according to how many letters have been received from the user interface so far.

According to on exemplary configuration of the present invention, a method is disclosed for word prediction of text input on an electronic device. In this example, the method comprises receiving from a user interface a number of letters including at least one letter as they are inputted by a user; performing word correction according to the received letters to thereby generate a set of first candidate words that have a number of letters being within a predetermined range; performing word completion according to the letters inputted by the user to thereby generate a set of second candidate words that have more letters than the number of letters inputted so far by the user; outputting a word candidate list via the user interface to allow the user to select a desired word, wherein words on the word candidate list are outputted in an order according to a priority ranking; and assigning a higher priority to the first candidate words and a lower priority to the second candidate words while the number of letters inputted by the user so far is within the predetermined range; and, after the number of letters inputted by the user has exceeded a maximum value of the predetermined range, assigning a higher priority to the second candidate words and a lower priority to the first candidate words.

According to another exemplary configuration of the present invention, a computer program is disclosed for instructing a processor to perform the above method.

According to another exemplary configuration of the present invention, an electronic device allowing text input is disclosed. In this example, the device comprises a user interface for receiving a number of letters including at least one letter as they are inputted by a user, and for outputting a word candidate list to allow the user to select a desired word, wherein words on the word candidate list are outputted in an order according to a priority ranking; an error correction unit for performing word correction according to the received letters to thereby generate a set of first candidate words that have a number of letters being within a predetermined range; a word completion unit for performing word completion according to the letters inputted by the user to thereby generate a set of second candidate words that have more letters than the number of letters inputted so far by the user; and a processor for assigning a higher priority to the first candidate words and a lower priority to the second candidate words while the number of letters inputted by the user so far is within the predetermined range; and, after the number of letters inputted by the user has exceeded a maximum value of the predetermined range, assigning a higher priority to the second candidate words and a lower priority to the first candidate words

According to another exemplary configuration of the present invention, an electronic device is disclosed allowing text input. In this example, the device comprises a first means for receiving a number of letters including at least one letter as they are inputted by a user, and for outputting a word candidate list to allow the user to select a desired word, wherein words on the word candidate list are outputted in an order according to a priority ranking; a second means for performing word correction according to the received letters to thereby generate a set of first candidate words that have a number of letters being within a predetermined range; a third means for performing word completion according to the letters inputted by the user to thereby generate a set of second candidate words that have more letters than the number of letters inputted so far by the user; and a fourth means for assigning a higher priority to the first candidate words and a lower priority to the second candidate words while the number of letters inputted by the user so far is within the predetermined range; and, after the number of letters inputted by the user has exceeded a maximum value of the predetermined range, assigning a higher priority to the second candidate words and a lower priority to the first candidate words.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a flowchart describing a method of word prediction of text input on an electronic device according to an exemplary configuration of the present invention.

FIG. 2 is a generalized table showing how the display priority utilized to chose the order of words displayed on the word candidate list changes after the number of letters entered by a user exceeds the maximum number N in the method of FIG. 1.

FIG. 3 is a simplified table showing particular words being displayed on a word candidate list for exemplary sequences of input letters being from one letter long to eight letters long according to one example of the present invention.

FIG. 4 is a flowchart describing a method of word prediction of text input on an electronic device according to another exemplary configuration of the present invention.

FIG. 5 is a hardware block diagram showing components for performing the steps of FIG. 1 and FIG. 4.

### DETAILED DESCRIPTION

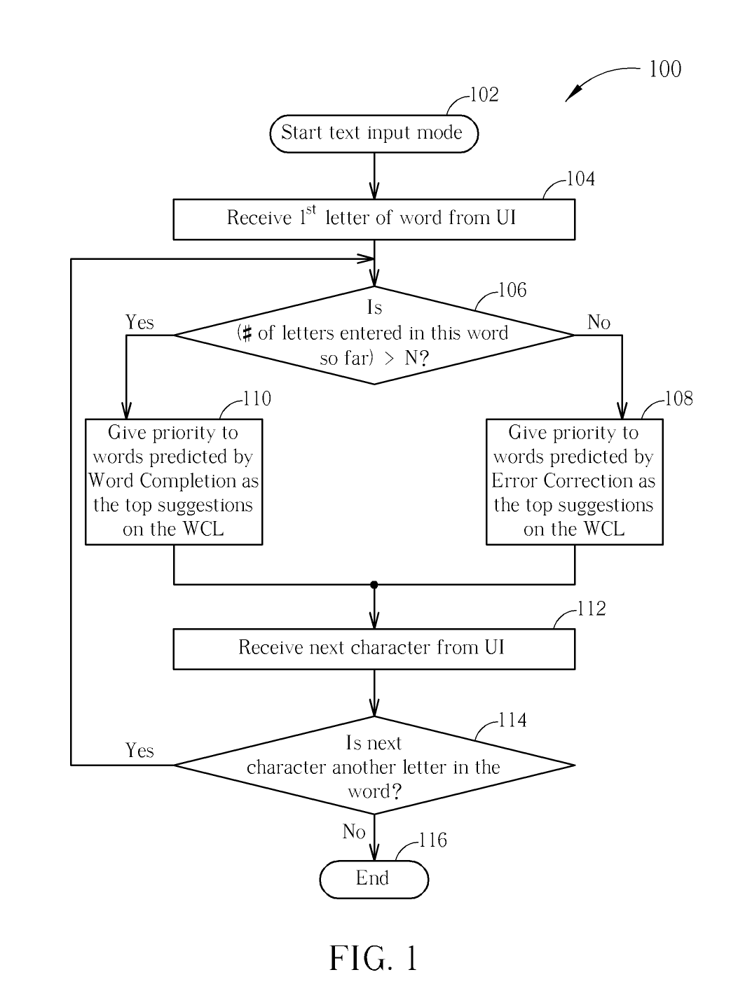

FIG. 1 is a flowchart describing a method of word prediction of text inputted into an electronic device by a user according to an exemplary configuration of the present invention.

To increase the usefulness of words that are presented to a user on a word candidate list (WCL) during prediction of text input on an electronic device, the display priority of different categories of candidate words on the WCL is adjusted according to how many letters have been entered in a current word so far by the user. Such operation increases word prediction accuracy because when a user starts to type the first few letters of a word, the possible list of words that the user may be trying to type is huge. Therefore, when only a few letters of a word have been entered so far, trying to guess which of possibly thousands of longer candidate words the user may be trying to type is statistically not going to be very successful. Instead, giving priority to shorter candidate words that are based on error correcting the actual letters that have been entered by the user so far provides a better accuracy rate. After a predetermined number of letters have been entered by the user, display priority on the WCL shifts to longer candidate words in an attempt to guess the ending of the word intended by the user. In this case, because the user has already entered a greater portion of the word, the number of possible longer candidate words is greatly reduced, and the probability of successfully guessing the right word for display on the WLC is correspondingly increased.

With reference to FIG. 1, a first method 100 of word prediction according to one example of the present invention includes the following steps:

Step 102: Start text input mode on the electronic device. For example, a user could switch the electronic device to a mode that allows the user to enter a short message service (SMS) or an e-mail message.

Step 104: Receive the first letter of a word from a user interface (UI) of the electronic device. For example, the user inputs the first letter of a word using the UI of the electronic device and the electronic device then receives it.

Step 106: Check if the number of letters entered in the current word by the user so far is greater than a predetermined number N. If yes, proceed to step 110; otherwise, proceed to step 108.

Step 108: Because only a few letters have been entered so far, give priority to words predicted utilizing error correction as the top suggestions on the WCL.

Step 110: Because many letters have already been entered, give priority to words predicted utilizing word completion as the top suggestions on the WCL.

Step 112: Receive a next character from the UI. For example, the user inputs a next character or letter code from the UI.

Step 114: Is the next character entered by the user in step 112 another letter in the word? For example, if the next character is another letter then it can be assumed that the next character is a next letter in the word. Likewise, if the next character is a non-letter such as a punctuation mark, enter or carriage return character, or a numerical digit, to list a few examples, then it may be assumed that the user is finished entering the current word. If the next character is another letter in the word, proceed back to step 106; otherwise, proceed to step 116.

Step 116: Finish the word prediction.

It should be noted that in this example, the first letter entered in step 104 and the predetermined number N in step 106 form a predetermined range (i.e., from 1 letter to N letters) to which preference will be given to error correction candidate words on the WCL. As long as the number of letters entered in a word so far falls within said predetermined range, step 108 will be activated to give priority to the words predicted by error correction. In other examples, the starting position of the range in step 104 can be something other than one, for example, by requiring at least two or more letters to be entered by the user in step 104. Additionally, provided that substantially the same result is achieved, the steps of the process 100 need not be in the exact order shown and need not be contiguous, that is, other steps can be intermediate. For example, more steps may be included showing the user selecting words from the WCL; however, for simplification purposes, these steps are omitted from FIG. 1.

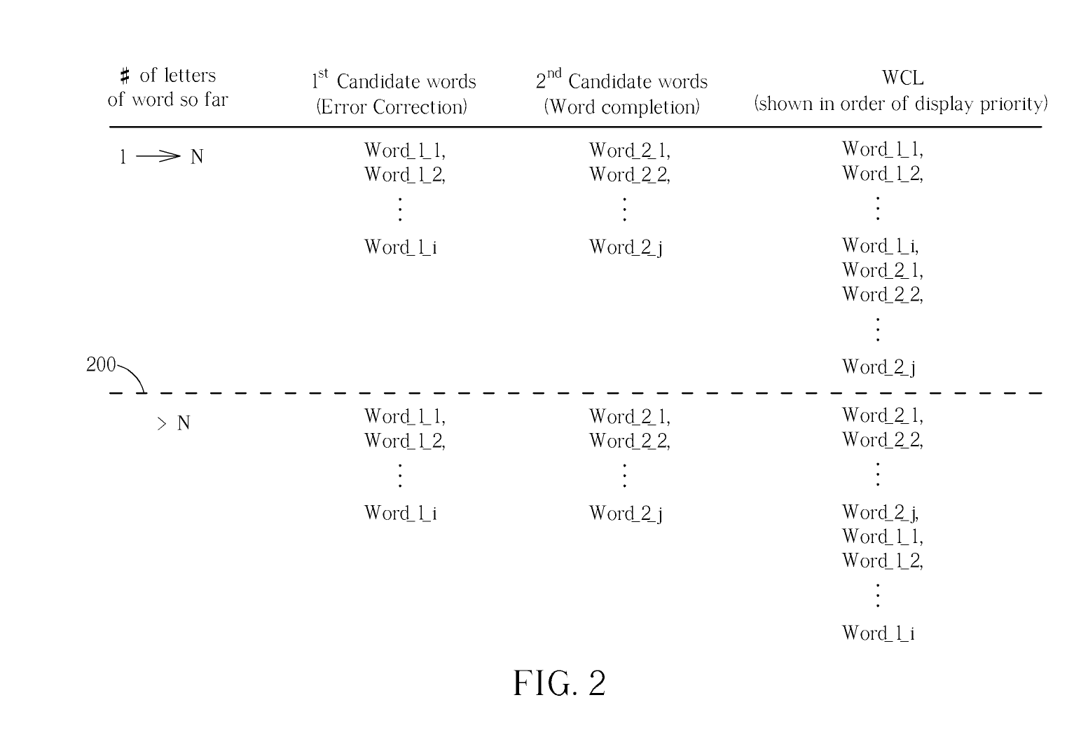

FIG. 2 is a generalized table showing how the display priority utilized to chose the order of words displayed on the word candidate list changes after the number of letters entered by a user exceeds the maximum value N of the predetermined range in the method of FIG. 1. In this example, the predetermined range is from one (1) letter to N letters, where N is typically an integer greater than 1. As each letter is inputted by the user, a set of first candidate words (Word_{—}1_{—}1 to Word_{—}1_i) are generated by error correcting the letters entered by the user, and a set of second candidate words (Word_{—}2_{—}1 to Word_{—}2_j) are generated by a word completion algorithm. In this example, the first candidate words (Word_{—}1_{—}1 to Word_{—}1_i) all have a number of letters being within the predetermined range of 1 to N letters long, and the second candidate words (Word_{—}2_{—}1 to Word_{—}2_j) all have a number of letters being greater than the number of letters inputted so far by the user.

As shown in FIG. 2, when the number of letters inputted by the user so far is within the predetermined range, indicated in FIG. 2 as the portion above the dotted line 200, the first candidate words (Word_{—}1_{—}1 to Word_{—}1_i) generated by error correcting the letters entered by the user are given higher priority and shown first on the WCL. After the number of letters entered by the user has exceeded the maximum value (N) of the predetermined range, indicated in FIG. 2 as the portion below the dotted line 200, the second candidate words (Word_{—}2_{—}1 to Word_{—}2_j) generated by the word completion algorithm are given higher display priority on the WCL.

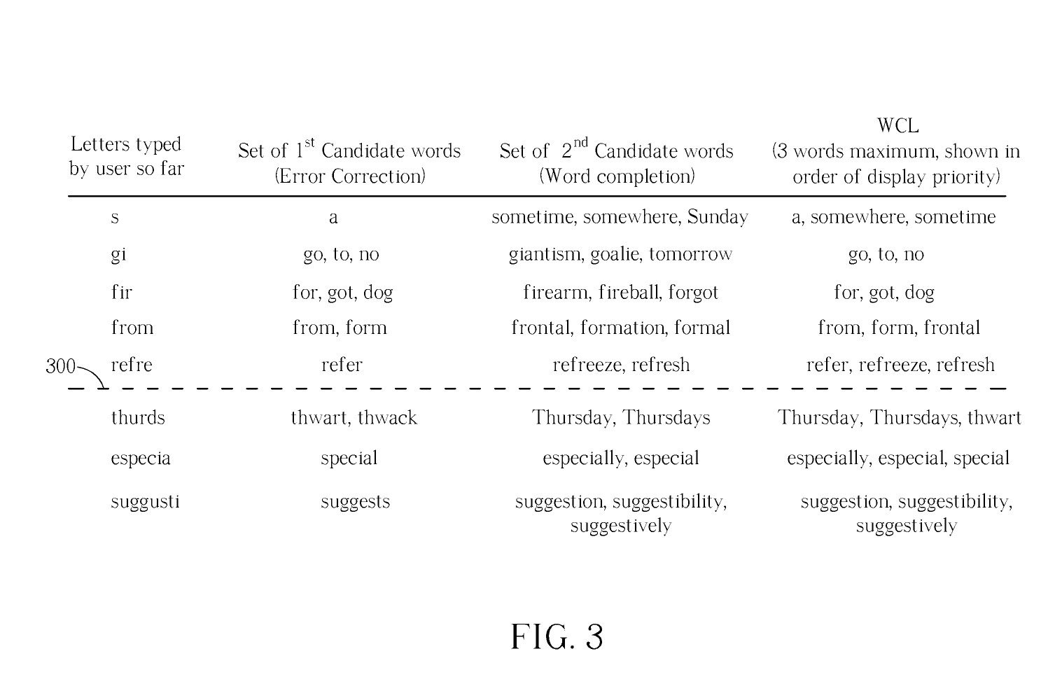

FIG. 3 is a simplified table showing particular words being displayed on a word candidate list (WCL) for exemplary sequences of input letters being from one letter long to eight letters long. In this example, the first candidate words are again generated by error correcting the letters received by the UI, and the second candidate words are generated by performing word completion to guess which possible word(s) the user may be in the process of typing. In this example, the WCL display priority shift, from first candidate words to second candidate words, occurs when the number of letters entered by the user so far exceeds a threshold value of five (i.e., exceeds 5 letters). In an attempt to further improve user experience, in this example, the first candidate words all have a number of letters being the same as the number of letters inputted by the user so far, and the second candidate words all have a number of letters being greater than the threshold value of five (5). FIG. 3 is simplified by limiting the set of first candidate words, the set of second candidate words, and the number of words to be displayed on the WCL to a maximum of three words each in order to facilitate the understanding of the present invention. In real world implementations, such simplifications may be omitted according to design requirements.

As shown in FIG. 3, while the number of letters inputted by the user so far is within a predetermined range of one to five, indicated in FIG. 3 as the portion above the dotted line 300, the first candidate words are given higher priority on the WCL. This means the first candidate word(s) are displayed first on the WCL and, if there is still room, the second candidate words are displayed following the first candidate words. One benefit of such operation is that it is faster for a user to select corrected versions of commonly mistyped short words such as “a”, “to”, “for”, “from”, “go”, “do”, “the”, “by”, etc. For example, prepositions and articles in English generally fall within the predetermined range of letters and are better predicted by error correcting the letters that have been entered so far rather than word prediction. After the number of letters entered by the user has exceeded the threshold value of five letters, the second candidate words are given higher priority in the WCL and are shown first. The benefit of this priority switch is that the user can now save time by not having to type a remaining portion of a word that can already be easily predicted by the electronic device.

Concerning the error correction utilized to generate the set of first candidate words, in one example, regional correction is utilized to correct errors made by the user hitting an incorrect letter being within a predetermined distance on the user interface from an intended letter. For example, in the first example of FIG. 3, the user inputted the single letter “s” and therefore the set of first candidate words contains a single word being “a”. The reason “a” is a highly likely candidate word when the user types “s” is because, on a standard QWERTY keyboard layout, the letter “a” is directly beside the letter “s”. Due to the small size of the keys, whether physical or virtual on a soft input panel or touch screen, it is highly likely that the user will often miss the intended letter “a” and instead inadvertently type a letter such as “s” that is within a predetermined distance on the user interface from the intended letter “a”. For this reason, the first candidate word “a” is given a higher priority on the WCL than longer second candidate words such as “somewhere” and “sometime”. Direct spelling correction to correct the spelling of words that are commonly misspelled can also be a part of the error correction utilized to generate the set of first candidate words. For example, in FIG. 3, the word “suggusti” is spell corrected to generate the first candidate word “suggests”.

Concerning the word completion utilized to generate the set of second candidate words, in one example, longer words are predicted that have a beginning portion corresponding to the letters inputted so far by the user. It should be mentioned that error correction such as regional and spelling correction can also be applied to the letters inputted so far by the user as a part of word completion to increase the effectiveness of word completion.

Also, for both error correction and word completion modes, context related prediction may be utilized such that if a user typed “prior” and then “space key” and then “r”, the prediction will correct “r” into “t” other than “e”, “d” or “f” or other letters close to “r” in QWERTY keyboard. The reason for this correction is because “prior to” is an often used phrase. So the context of the words in a sentence may be analyzed to assist with error correction and word completion.

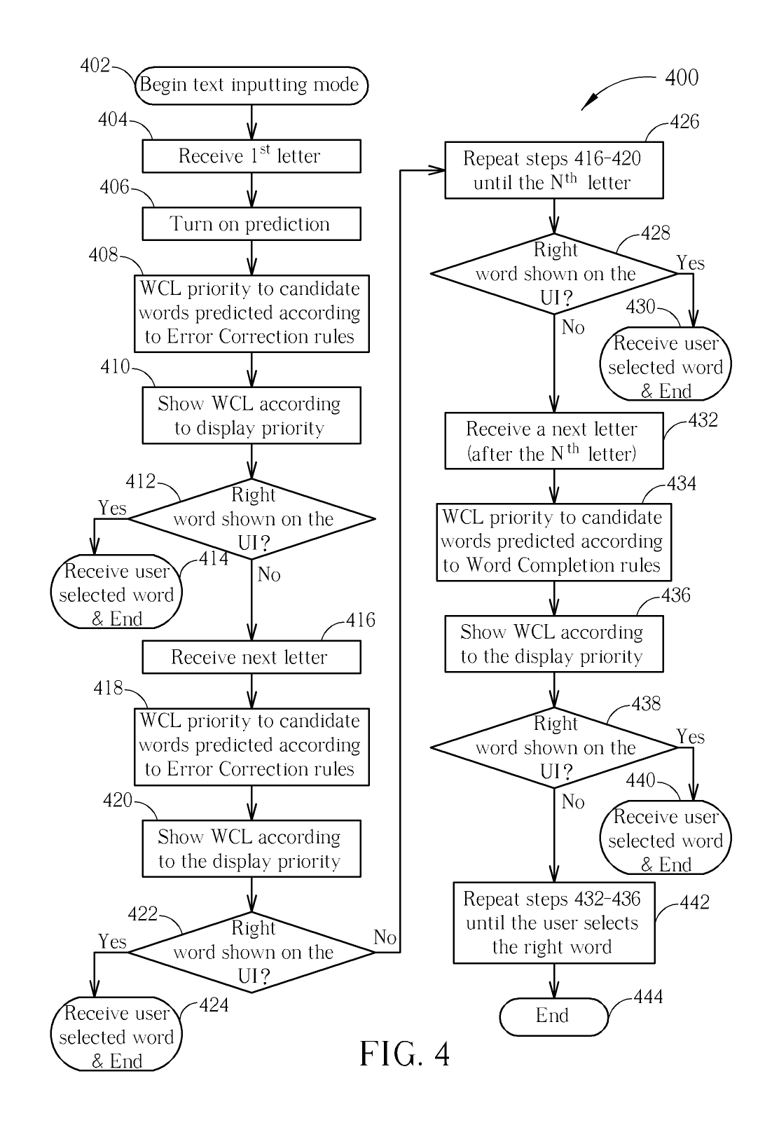

FIG. 4 is a flowchart of describing a method 400 of word prediction of text input on an electronic device according to another exemplary configuration of the present invention. Provided that substantially the same result is achieved, the steps of the method 400 need not be in the exact order shown and need not be contiguous, that is, other steps can be intermediate.

Step 402: Begin text entering mode.

Step 404: Receive a 1^{st} letter of a word from a UI.

Step 406: Turn on word prediction module.

Step 408: Give higher WCL display priority weighting to candidate words predicted according to Error Correction rules.

Step 410: Show at least some of the predicted words on the WCL on the UI according to the display priority.

Step 412: Is the right word shown on the UI? If yes, proceed to step 414; otherwise, proceed to step 416.

Step 414: Receive correct word selection from UI. For example, the user selects the correct word from the WCL and the flow ends because the word is finished.

Step 416: Receive next letter from UI.

Step 418: Give higher WCL display priority weighting to candidate words predicted according to Error Correction rules.

Step 420: Show at least some of the predicted words on the WCL on the UI according to the display priority.

Step 422: Is the right word shown on the UI? If yes, proceed to step 424; otherwise, proceed to step 426.

Step 424: Receive correct word selection from UI. For example, the user selects the correct word from the WCL and the flow ends because the word is finished.

Step 426: Repeat steps 416-420 until the N^{th} letter is entered.

Step 428: Is the right word shown on the UI? If yes, proceed to step 424; otherwise, proceed to step 426.

Step 430: Receive correct word selection from UI. For example, the user selects the correct word from the WCL and the flow ends because the word is finished.

Step 432: Receive a next letter (after the N^{th} letter) from the UI.

Step 434: Give higher WCL display priority weighting to candidate words predicted according to Word Completion rules.

Step 436: Show at least some of the predicted words on the WCL on the UI according to the display priority.

Step 438: Is the right word shown on the UI? If yes, proceed to step 440; otherwise, proceed to step 442.

Step 440: Receive correct word selection from UI. For example, the user selects the correct word from the WCL and the flow ends because the word is finished.

Step 442: Repeat steps 432-436 until the user selects the right word.

Step 444: The user is finished entering the current word.

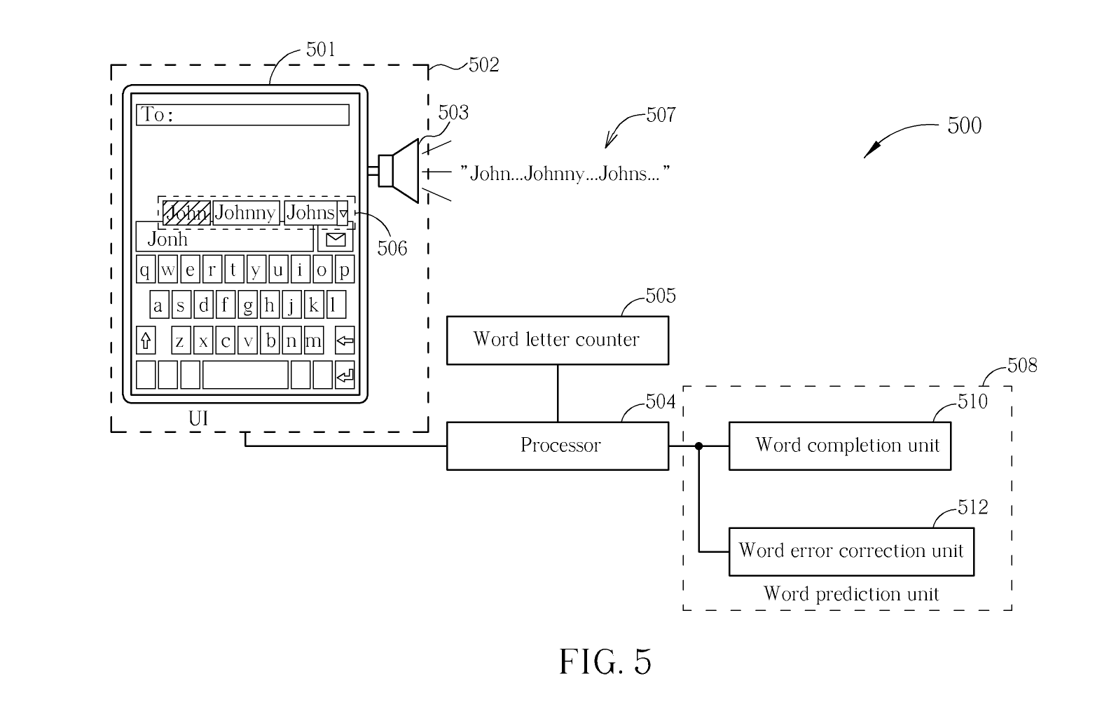

FIG. 5 is exemplary hardware block diagram showing components for performing the steps of the methods shown in FIG. 1 and FIG. 4. In this example, the electronic device is a mobile phone 500 including a user interface (UI) 502, a processor 504, a word letter counter 505, and a word prediction unit 508. In this example, the UI 502 includes a soft input panel (SIP) 501 including a touch screen displaying a word candidate list (WCL) 506 and soft keyboard for text entry. The word prediction unit 508 includes a word completion unit 510 and an error correction unit 512. Both of these units could be implemented as either hardware circuits or software modules.

In this example, the predetermined range for giving priority to words predicted using the error correction unit 512 is from 1 word to 5 words. The counter 502 is reset to zero after a predetermined non-letter is received from the user interface to indicate the end of the word. As shown, four letters (J, o, n, h) have been inputted so far by a user on the UI 502, and therefore the number four will be stored in the counter 505 at the time of this example. The priority ranking of first and second candidate words generated respectively from the error correction unit 512 and the word completion unit 510 is performed according to whether or not the value of the counter 505 is within the predetermined range of 1 to 5. Because the number of letters entered so far (4) is not above the maximum of the range (5), the error correction unit 512 has generated a first candidate word “John” and this candidate word is given top priority by the processor 504 and shown first on the WCL 506. The word completion unit 510 has also generated second candidate words “Johnny” and “Johns” and these words are given lower priority on the WCL 506 and are therefore shown after the first candidate word “John”. In other examples, any form of a display portion of the UI 502 may be utilized to display the word WCL 506. That is, it is not necessary that a touch screen be utilized.

In yet another exemplary configuration, the user interface 502 includes a speaker 503 utilized to audibly broadcast the word candidate list 507 to the user. In this example, the order that the words are broadcast from the speaker 503 is according to the priority ranking so the candidate words having higher priority would be broadcast before the candidate words having lower priority. The speaker may also operate as or incorporate a microphone so the user may input letters or select a desired word from the WCL 507 using voice commands.

In addition to mobile phones with touch screens, the electronic device may be any device which is capable of inputting text including a desktop computer, a lap top computer, a notebook computer, a digital camera, a personal data assistant (PDA), an MP3 or other type of music player, a game device, a personal navigation device (PND), or any other device with a processor. Also, it should be noted that devices having touch screens benefit from the word prediction according to the present invention because it is easy to make errors when typing on a touch screen, but in fact, all text input systems will benefit from the present invention by speeding text entry by users.

All combinations and sub-combinations of the above-described features also belong to the invention. Additionally, the methods disclosed herein may be implemented in hardware, or as a computer software program to control a processor being stored in/on, or operating in conjunction with RAM, ROM, EEPROM, flash memory, an optical disc, a magnetic disk, etc.

Those skilled in the art will readily observe that numerous modifications and alterations of the device and method may be made while retaining the teachings of the invention.

What is claimed is:

1. A method for word prediction of text input on an electronic device, the method comprising:
receiving from a user interface a number of letters including at least one letter as they are inputted by a user;
performing word correction according to the received letters to thereby generate a set of first candidate words that have a number of letters being within a predetermined range;
performing word completion according to the letters inputted by the user to thereby generate a set of second candidate words that have more letters than the number of letters inputted so far by the user;
outputting a word candidate list via the user interface to allow the user to select a desired word, wherein words on the word candidate list are outputted in an order according to a priority ranking; and
assigning a higher priority to the first candidate words and a lower priority to the second candidate words while the number of letters inputted by the user so far is within the predetermined range; and, after the number of letters inputted by the user has exceeded a maximum value of the predetermined range, assigning a higher priority to the second candidate words and a lower priority to the first candidate words.

2. The method of claim 1, further comprising:
counting the number of letters received by the user interface in a counter;
resetting the counter after a predetermined non-letter is received from the user interface; and
assigning the priority ranking of the first and second candidate words for outputting the word candidate list according to whether or not a value of the counter is within the predetermined range.

3. The method of claim 2, wherein the predetermined non-letter is a space character, an enter character, a punctuation character, or a numerical digit.

4. The method of claim 1, wherein the first candidate words have a same number of letters as the number of letters inputted so far by the user.

5. The method of claim 1, wherein the second candidate words have a number of letters exceeding the maximum value of the predetermined range.

6. The method of claim 1, wherein performing word correction comprises performing regional letter correction to correct errors made by the user hitting an incorrect letter being within a predetermined distance on the user interface from an intended letter.

7. The method of claim 1, wherein performing word correction comprises performing spelling correction to correct spelling of words that are commonly misspelled.

8. The method of claim 1, wherein performing word completion comprises predicting words that have a beginning portion corresponding to the letters inputted so far by the user.

9. The method of claim 1, wherein the predetermined range is from one letter to a number of letters being less than or equal to five.

10. The method of claim 1, wherein the electronic device is a mobile phone, and the user interface is a soft input panel of the mobile phone.

11. The method of claim 1, wherein outputting the word candidate list further comprises displaying the word candidate list on a display portion of the user interface, candidate words having higher priority being displayed before candidate words having lower priority.

12. The method of claim 1, wherein outputting the word candidate list further comprises audibly broadcasting the word candidate list from a speaker of the user interface, candidate words having higher priority being broadcast before candidate words having lower priority.

13. A computer program for instructing a processor to perform the method of claim 1.

14. An electronic device allowing text input, comprising:
a user interface for receiving a number of letters including at least one letter as they are inputted by a user, and for outputting a word candidate list to allow the user to select a desired word, wherein words on the word candidate list are outputted in an order according to a priority ranking;
an error correction unit for performing word correction according to the received letters to thereby generate a set of first candidate words that have a number of letters being within a predetermined range;
a word completion unit for performing word completion according to the letters inputted by the user to thereby generate a set of second candidate words that have more letters than the number of letters inputted so far by the user; and
a processor for assigning a higher priority to the first candidate words and a lower priority to the second candidate words while the number of letters inputted by the user so far is within the predetermined range; and, after the number of letters inputted by the user has exceeded a maximum value of the predetermined range, assigning a higher priority to the second candidate words and a lower priority to the first candidate words.

15. The electronic device of claim 14, further comprising:
a counter for counting the number of letters received by the user interface;
wherein the processor is further for resetting the counter after a predetermined non-letter is received from the user interface, and assigning the priority ranking of the first and second candidate words for outputting the word candidate list according to whether or not a value of the counter is within the predetermined range.

16. The electronic device of claim 15, wherein the predetermined non-letter is a space character, an enter character, a punctuation character, or a numerical digit.

17. The electronic device of claim 14, wherein the first candidate words have a same number of letters as the number of letters inputted so far by the user.

18. The electronic device of claim 14, wherein the second candidate words have a number of letters exceeding the maximum value of the predetermined range.

19. The electronic device of claim 14, wherein the error correction unit is for performing regional letter correction to correct errors made by the user hitting an incorrect letter being within a predetermined distance on the user interface from an intended letter.

20. The electronic device of claim 14, wherein the error correction unit is for performing spelling correction to correct spelling of words that are commonly misspelled.

21. The electronic device of claim 14, wherein the word completion unit is for predicting words that have a beginning portion corresponding to the letters inputted so far by the user.

22. The electronic device of claim 14, wherein the predetermined range is from one letter to a number of letters being less than or equal to five.

23. The electronic device of claim 14, wherein the electronic device is a mobile phone, and the user interface is a soft input panel of the mobile phone.

24. The electronic device of claim 14, wherein the user interface is further for outputting the word candidate list by displaying the word candidate list on a display portion, candidate words having higher priority being displayed before candidate words having lower priority.

25. The electronic device of claim 14, wherein the user interface is further for outputting the word candidate list by audibly broadcasting the word candidate list from a speaker, candidate words having higher priority being broadcast before candidate words having lower priority.

26. An electronic device allowing text input, comprising:
a first means for receiving a number of letters including at least one letter as they are inputted by a user, and for outputting a word candidate list to allow the user to select a desired word, wherein words on the word candidate list are outputted in an order according to a priority ranking;
a second means for performing word correction according to the received letters to thereby generate a set of first candidate words that have a number of letters being within a predetermined range;
a third means for performing word completion according to the letters inputted by the user to thereby generate a set of second candidate words that have more letters than the number of letters inputted so far by the user; and
a fourth means for assigning a higher priority to the first candidate words and a lower priority to the second candidate words while the number of letters inputted by the user so far is within the predetermined range; and, after the number of letters inputted by the user has exceeded a maximum value of the predetermined range, assigning a higher priority to the second candidate words and a lower priority to the first candidate words.
